(19) United States
(12) Patent Application Publication
(10) Pub. No.: US 2023/0345946 A1
(43) Pub. Date: Nov. 2, 2023

(54) ANTIVIRAL SURFACES COMPRISING POLYOXOMETALATES AND ZINC MOLYBDATE

(71) Applicant: FRIDA GROUP APS, Dragor (DK)

(72) Inventor: Peter J. GUGGENBICHLER, Kossen in Tirol (AT)

(73) Assignee: FRIDA GROUP APS, Dragor (DK)

(21) Appl. No.: 18/006,081

(22) PCT Filed: Jul. 19, 2021
(86) PCT No.: PCT/EP2021/070144

§ 371 Date: Jan. 19, 2023

(30) Foreign Application Priority Data
Jul. 20, 2020 (EP) 20186706.6

(51) Int. Cl. A01N 59/16; A01N 25/12; A01P 1/00; C09D 5/14; C09D 1/00

(52) U.S. Cl. CPC A01N 59/16; A01N 25/12; A01P 1/00; C09D 5/14; C09D 1/00

(57) ABSTRACT

The invention relates to antiviral compositions comprising polyoxometalates and zinc molybdate to combat viruses and in particular coronaviruses.

The invention relates to antiviral compositions comprising polyoxometalates and zinc molybdate to combat viruses and in particular coronaviruses.

To prevent the accumulation of viruses, surfaces of objects are treated with antiviral agents or given antiviral properties. Disinfectants, among other things, are used to combat viruses. However, a major disadvantage of using disinfectants is the development of resistance and cross-resistance among microorganisms also present on the surfaces to be disinfected. Therefore, alternatives are increasingly looked for to combat microorganisms effectively and prevent surfaces from being colonised by microorganisms. One possibility is to use metals and metal compounds. Silver and copper are often used in particular, due to their good antiviral properties. In a first variant, the elemental metal is provided in a form having the largest possible surface area in order to achieve high activity. Nanoparticles, foamed metal or nanoparticles fixed on a carrier are of particular interest in this regard. A second variant uses soluble metal salts, for example, incorporated into zeolites or directly into composite materials. A disadvantage, however, is that the said noble metals or noble metal ions are comparatively expensive and, moreover, almost completely inactivated by sulphur-containing compounds or by high electrolyte concentrations.

Recently, the use of polyoxometalates as antiviral agents has also been discussed. Among other possibilities, the effectiveness of polyoxometalates against viruses in a surface doped with titanium has been described. Titanium 30 is used to form an electrostatic potential and free radicals such as oxygen radicals to enhance the effectiveness of polyoxometalates.

Polyoxotungstates are known for their anti-influenza virus activity.

The task of the present invention is to provide improved antiviral compositions and/or surfaces containing polyoxometalates. The task according to the invention is solved by adding zinc molybdate (ZnMoO₄) to the polyoxometalates or by providing mixtures comprising zinc molybdate and polyoxometalates.

Polyoxometalates in the context of the invention are a group of substances comprising polyatomic anions. These are made up of three or more transition metal oxianions and are displaced by oxygen atoms. Polyoxometalates can form a large, closed three-dimensional network.

The metal atoms are usually transition metal atoms of groups V or VI of the periodic table in high oxidation numbers, that is to say, the electron configurations d⁰ or d¹. Examples are vanadium (V), niobium (V), tantalum (V), molybdenum (VI) and tungsten (VI).

Processes for producing polyoxometalates are known to persons skilled in the art. Two methods are generally used for this purpose. Firstly, the protonation of oxo ligands of the metal cation in acidic solution, forming an H₂O ligand that can be cleaved from the central metal atom, leading to condensation of the mononuclear oxometalates, and secondly, by condensation reaction of polyacids in basic medium. Polyoxometalate frameworks of different sizes can be formed depending on the pH value of the solution.

As biocides generated in situ, polyoxometalates have antibacterial effects against numerous pathogenic microorganisms such as hepatitis B, hepatitis C, enveloped viruses such as herpes viruses and coronaviruses, as well as a wide range of bacterial microorganisms, regardless of their resistance to antibiotics, and fungi including moulds and algae.

The broad antimicrobial efficacy of polyoxometalates is based on the synergistic effectiveness of three mechanisms, resulting in the rapid elimination of viral and bacterial microorganisms and fungi in situ on surfaces.

These are
the formation of free radicals such as oxygen radicals, and hydroxyl ions from the water in air humidity;
the formation of acidic water molecules on the surface resulting in a pH value of 4.5 on the surface, similar to the pH value of the skin;
the formation of a positive zeta potential, leading to electrostatic properties of the surface in the micrometre range. Electrostatic surface charging also shows antibacterial and antiviral properties. Electronegatively charged microorganisms are attracted to the positively electrostatically charged surfaces and break apart within minutes of coming into contact with the surface. This has been documented for bacterial microorganisms through laser scanning microscopy.

These polyoxometalates can be incorporated either into a polymer surface or into a transparent coating such as, for example, liquid polyurethane, liquid silicone and other coating materials such as lacquers, which preferably dry within one hour. Various coating materials have already been developed to receive polyoxometalates. Their effectiveness lasts for at least 10 years and has been confirmed with corresponding studies. Their efficacy is not affected by surfactants, alcohol or water.

According to the invention, and surprisingly, maintenance of the electrostatic potential, and thus the antibacterial, particularly the antiviral effect, is enhanced by the further addition of zinc molybdate (ZnMoO₄).

Zinc molybdate usually has a tetragonal crystal structure. It is insoluble in water and therefore practically non-toxic. Besides the known tetragonal crystal structure, zinc molybdate with a triclinic crystal structure shows significantly higher antiviral efficacy. The effect is significantly improved compared to that of tetragonal zinc molybdate having the same grain size.

Triclinic zinc molybdate can be obtained by ultrasound-assisted reaction of a solution of one or more water-soluble molybdates with a solution of one or more water-soluble zinc (II) salts. In the presence of ultrasound, the water-insoluble zinc molybdate formed during the reaction of the educt salts precipitates in the form of triclinic crystals. The grain size of the triclinic crystals can vary depending on the duration of the reaction and the sonication.

Particularly good antiviral effectiveness was found according to the invention for zinc molybdate in the form of particles having a triclinic crystal structure and an average grain size in the range from 0.10 μm to 5.0 μm, preferably between 0.25 μm and 5.0 μm.

The use of zinc molybdate in the mixture according to the invention is therefore preferred for ZnMoO₄ present in the form of particles with a triclinic crystal structure and an average grain size between 0.1 μm and 5.0 μm, preferably 0.25 μm and 5.0 μm. According to a further embodiment, the use of triclinic ZnMoO₄ having an average grain size in the sub-micron range, that is to say, from 0.1 μm to less than 1.0 μm, is preferred. In further preferred embodiments, the triclinic zinc molybdate has a particle size in the range of 0.15 μm to <1 μm and more preferably in the range of 0.20 μm to 0.8 μm.

Triclinic zinc molybdate is non-toxic to humans and animals and therefore has excellent biocompatibility. It can be produced comparatively inexpensively and shows a strong antiviral effect even in small quantities. In addition, zinc molybdate is not inactivated by sulphur-containing compounds or by a high concentration of electrolytes, but rather retains its effectiveness.

Zinc molybdate having a triclinic crystal structure and the grain size given above shows high antiviral activity against a broad spectrum of microorganisms, including algae, fungi and enveloped viruses, as well as gram-positive and gram-negative microorganisms, regardless of their antibiotic resistance. Examples of microorganisms against which triclinic zinc molybdate according to the invention is effective include, inter alia, Lactobacillus acidophilus, Pseudomonas, for example P. aeruginosa, Salmonella, for example S. aureus, E. coli, Candida Spp, C. albicans, C. glabrata and C. tropicalis, Legionella, listerias; viruses such as influenza, Epstein-Barr virus, rotaviruses and norovirus; as well as Aspergillus niger, fumigatus and flavus.

Accordingly, a preferred aspect of the invention relates to the use of a mixture comprising polyoxometalates and zinc molybdate (ZnMoO₄), preferably in the form of particles having a triclinic crystal structure and an average particle size between 0.1 μm and 5.0 μm, for combating microorganisms, the microorganisms being preferably viruses, preferably influenza viruses, hepatitis B viruses, flavivirus, HIV, Epstein-Barr virus (EBV), norovirus, hepatitis C viruses, enveloped viruses such as herpes viruses and/or coronaviruses. Other microorganisms suitable for control according to the invention have been described previously in relation to the use of polyoxometalates and/or zinc molybdate on their own.

Combating viruses in the context of the invention means the killing of viruses and/or any virus inactivation. Virus inactivation of at least 90% is preferred.

According to the invention, coronaviruses preferably include orthocoronaviruses, such as in particular betacoronaviruses (Beta-CoV), such as SARS-CoV-2 (2019-nCoV), SARS-CoV, and/or MERS-CoV. They also include mutants of these viruses and in particular Alpha (B.1.1.7), Beta (B.1.351), Gamma (P.1), Lambda (C.37), B.1.525 or Delta (B.1.617, B.1.617.1, B.1.617.2) mutations of SARS-CoV-2.

A particularly preferred aspect relates to the use of a mixture comprising polyoxometalates and zinc molybdate (ZnMoO₄), preferably in the form of particles having a triclinic crystal structure and an average particle size between 0.1 μm and 5.0 μm, for combating SARS-CoV-2 (2019-nCoV).

The polyoxometalate used according to the invention preferably comprises vanadium (V), niobium (V), tantalum (V), molybdenum (VI) and/or tungsten (VI). Molybdenum (VI), tungsten (VI) and mixtures thereof are particularly preferred. In mixtures of molybdenum (VI) and tungsten (VI), atomic ratios of 3:1 to 1:3 and especially 1:1 or 2:1 are preferred.

An example of a preferred polyoxometalate is [H₂Mo₆W₆O₄₂]¹⁰⁻.

In the mixture according to the invention, polyoxometalate and zinc molybdate are preferably used in a weight ratio of 10:1 to 1:10, more preferably 5:1 to 1:5 and even more preferably approx. 2:1.

The grain size of ZnMoO₄ is preferably in the range of 0.10-2.5 μm, more preferably in the range of 0.15-2.5 μm, and more preferably in the range of 0.15 μm to less than 1.0 μm, more preferably in the range of 0.2 μm to 0.8 μm. The invention does not envisage particles smaller than 0.10 μm and in particular nanoparticles. It has been found that, with a triclinic crystal structure of zinc molybdate having an average grain size in the micrometre range, excellent antiviral effectiveness is achieved, so that the risks associated with nanoparticles can be avoided. Zinc molybdate having a triclinic crystal structure is particularly effective in the sub-micron range.

Triclinic zinc molybdate itself is insoluble in water. On contact with water or air humidity, zinc molybdate causes a lowering of the pH value. The zinc molybdate itself does not go into solution and is not broken down or washed out of a material.

For antiviral use, the mixture according to the invention can be used alone or in combination with other active ingredients and/or adjuvants. In a particularly preferred embodiment, the mixture according to the invention is combined with molybdenum oxide Mo0₃, since this allows the antiviral effectiveness to be improved even further. Mo0₃ can in principle have any desired crystal structure, for example orthorhombic or monoclinic. Mo0₃ having an orthorhombic crystal structure has proven to be particularly advantageous according to the invention. Triclinic ZnMoO₄ and Mo0₃ can be present in the form of a mixture of crystals or as mixed crystals.

Further advantages result when polyoxometalate and zinc molybdate are used according to the invention in combination with at least one hydrophilicising or hygroscopic agent. Particularly preferred hydrophilicising and hygroscopic agents are described below.

According to the invention, the mixture comprising polyoxometalate and zinc molybdate can be incorporated into a material which is to be provided with antiviral properties, or at least deposited on its surface. This results in an antivirally effective composite material. Such a composite material constitutes another aspect of the present invention.

In the context of the present invention, a composite material is understood to mean a material consisting of three or more materials combined together, at least two of the materials being the polyoxometalate and the zinc molybdate as defined above. The at least one further material can in principle be formed from any material and, for example, also be a composite material itself.

The presence of polyoxometalate and zinc molybdate imparts a biocidal effect, in particular an antiviral effect, to a composite material according to the invention. Since a lowering of the pH value, which in particular damages and/or destroys the coating of viruses, is only required in the region of the surface boundary layer of the composite material or of a component or product made therefrom, correspondingly small amounts of polyoxometalate and zinc molybdate in the region of the surface are sufficient to achieve the desired antiviral efficacy.

Polyoxometalate and zinc molybdate are substantially insoluble in water, so that they are not washed out of the composite material but remain there, maintaining their antiviral efficacy throughout the life of the composite material. In this context, it is known that triclinic zinc molybdate is retained in the material even better than zinc molybdate having a different crystal structure.

The at least one further material of the composite material can in principle be selected from any material classes. For example, it can be an inorganic, metallic, ceramic or organic material or any combinations thereof. Other possible materials are, for example, plastics (e.g. TPU, PE, PP, HDPE, polystyrene, polyimine, etc.), paints, lacquers, silicones, rubber, caoutchouc, melamine, acrylates, methylacrylates, waxes, epoxy resins, glass, metal, ceramics and others. In a preferred embodiment, the composite material according to the invention comprises at least one organic polymer or a compound and/or a silicone as a further material. The material into or onto which the polyoxometalate and the zinc molybdate are introduced for the purpose of the antiviral finish can form a solid and/or liquid matrix. It may be envisaged that polyoxometalate and zinc molybdate are added in such a way that they make up between 0.1% and 10% (by weight or by volume) of the total weight or total volume.

The composite material can in principle be designed as a layer composite, fibre composite, particle composite or penetrating composite.

In principle, the composite material according to the invention can be solid or liquid under standard conditions. For example, the composite material can be in the form of a solution, suspension and/or dispersion, for example as a lacquer or liquid coating agent. The mixture of polyoxometalate and zinc molybdate according to the invention is preferably used as a lacquer or liquid coating agent. In such a case, curing of the composite material preferably takes place after application.

Lacquers or coating agents according to the invention can be applied to any suitable surface such as plastics, textiles, metals, wood, stone and other building materials. The composite material according to the invention is preferably applied to surfaces that may come into contact with possible virus carriers, such as door handles, handrails on stairs and escalators, handrails and other holding devices on public transport, any input devices such as ATMs, ticket vending machines, drinks vending machines, cigarette vending machines, any other input and/or output machines, etc., but also textile or plastic seats, especially in waiting areas, means of transport such as buses or trains, any other means of public transport, aircraft, taxis, carpeted floors, or any surfaces in doctors' surgeries or hospital rooms.

One aspect of the invention relates to a face mask to which the mixture of polyoxometalate and zinc molybdate according to the invention has been applied. The face mask preferably covers at least the mouth and nose area. The mask can be made of any material commonly used for this purpose, such as textile. The mixture of polyoxometalate and zinc molybdate according to the invention may be applied to the side facing the mask wearer and/or the side facing away from the wearer. Compared to conventional masks, the mask according to the invention has the advantage that not only are viruses held back by the filter function of the mask, but the coating of polyoxometalate and zinc molybdate according to the invention also kills or inactivates the viruses.

The mixture according to the invention may be disposed on the surface of the composite material and/or distributed in the composite material. According to the invention, the mixture is preferably disposed in the region of the surface of the composite material, since an antiviral effect is desired here. For example, the mixture can be applied as a layer or component of a layer on a substrate or carrier material. In principle, only one region or a plurality of regions of the surface or the entire surface of the composite material can be antivirally finished with the mixture. Alternatively or in addition, the mixture can also be disposed within the composite material or distributed in the composite material. This ensures that the antiviral effect is permanently maintained even if the composite material wears on its surface.

Depending on the intended use, the composite material in the context of the present invention can in principle be present as a semi-finished product, that is to say, as a semi-finished material which only reaches its final form of use after further processing steps. Alternatively, the composite material can already be designed as a finished component, which can be used for its desired purpose without further processing steps.

A composite material according to the invention can contain the mixture alone or in combination with other active ingredients and/or adjuvants. In a particularly preferred embodiment, the mixture is combined with molybdenum oxide Mo0₃, since this allows the antiviral effectiveness to be improved even further. Mo0₃ can in principle have any desired crystal structure, for example orthorhombic or monoclinic. Mo0₃ having an orthorhombic crystal structure has proven to be particularly advantageous according to the invention. The mixture and Mo0₃ can be present in the form of a mixture of crystals or as mixed crystals. The use of a mixture or mixed crystal of polyoxometalate, zinc molybdate and orthorhombic Mo0₃ is particularly preferred.

In a preferred embodiment, a composite material according to the invention has, in addition to the mixture according to the invention and possibly Mo0₃, no additional antiviral compounds, such as silver or silver compounds, in particular nanosilver or soluble silver compounds such as silver nitrate or the like. Copper, organic biocides, zeolites and the like are also preferably not contained in a composite material according to the invention. This results in better environmental compatibility and a considerable reduction in costs. Of course this does not however rule out the possibility that in other embodiments the composite material may incorporate other antimicrobially and/or antivirally active substances, such as silver, copper, biocides, polyoxometalate, etc., in addition to the mixture according to the invention.

The mass content of the mixture based on the total mass of the composite material is advantageously between 0.1 and 80% by weight, in particular between 1.5 and 30% by weight and preferably between 1.8 and 5.0% by weight. This mass ratio ensures particularly high antiviral efficacy with the lowest possible material input of mixture.

The use of particles with the aforementioned average grain sizes offers the particular advantage that, on the one hand, a particularly high antiviral efficacy can be achieved and, on the other hand, the composite material according to the invention is free of nanoparticles.

Further advantages result if the mixture is used in combination with at least one hydrophilicising or hygroscopic agent which is disposed at least in the region of the surface of the composite material. This significantly increases antiviral efficacy in particularly dry environments, that is to say, for example, with very low air humidity and correspondingly small amounts of available water, which are important for the formation of an acidic surface boundary layer. Examples of suitable hydrophilicising and/or hygroscopic agents are, in particular, SiO₂, in particular in the form of silica gel or as pyrogenic silicon dioxide. These form a kind of moisture buffer and thus ensure a minimum level of moisture in the product.

Further examples of other hydrophilicising and/or hygroscopic agents that can be used according to the invention are organic acids, such as abietic acid, arachidonic acid, arachidic acid, behenic acid, capric acid, caproic acid, cerotic acid, erucic acid, fusaric acid, fumaric acid, bile acids, icosenoic acid, isophthalic acid, lactonic acid, laurinic acid, lignoceric acid, linolenic acid, levopimaric acid, linoleic acid, margaric acid, melissic acid, montanic acid, myristic acid, neoabietic acid, nervonic acid, nonadecanoic acid, oleic acid, palmitic acid, palmitoleic acid, pelargonic acid (nonanoic acid), pimaric acid, palustric acid, palmitic acid, ricinic acid, stearic acid, sorbic acid, tannic acid, tridecanoic acid, undecanoic acid and vulpinic acid. Furthermore, malonic acid, maleic acid and maleic anhydride, lactic acid, acetic acid, citric acid, salicylic acid and ascorbic acid and their salts have proven to be advantageous. Acid anhydrides, ampholytic substances, buffer systems, polymer acids, ion exchange resins, as well as acid sulfonates and acid halides can also be used.

The mass content of hydrophilicising and/or hygroscopic agent based on the total weight of the composite is advantageously in the range from 0.1% to 15%. For example, the mass content can be 0.5%, 1%, 2%, 3%, 4%, 5%, 6%, 7%, 8%, 9%, 10%, 11%, 12%, 13% or 14%. A mass content in the range between 1 and 5%, preferably in the range from 2-4%, is particularly advantageous. Furthermore, the mass content or the mass ratio of the hydrophilicising and/or hygroscopic agent can be set in such a way that it corresponds to the selected mass content of the mixture of polyoxometalate and zinc molybdate.

In a particularly preferred embodiment, the mixture of polyoxometalate and zinc molybdate is at least partially coated and/or agglomerated with the hydrophilicising and/or hygroscopic agent, in particular SiO₂. This is a simple way of ensuring that the two classes of compounds are in close spatial proximity, so that the mixture of polyoxometalate and zinc molybdate is immediately provided with the moisture required to lower the pH value, even under particularly dry conditions.

A further aspect of the present invention provides for the use of an antivirally active composite material as defined above for the production of an antivirally active product.

Another aspect of the invention relates to an in vitro method for combating viruses, in particular coronaviruses, whereby polyoxometalate and zinc molybdate (ZnMoO₄), preferably having a triclinic crystal structure and an average particle size between 0.1 μm and 5.0 μm, are brought into contact with a composition suspected of containing viruses, in particular coronaviruses. Polyoxometalate and ZnMoO₄ are preferably used in the form of a composite material which has polyoxometalate and/or ZnMoO₄ at least on its surface, the latter preferably in the form of particles with a triclinic crystal structure and an average particle size between 0.1 μm and 5.0 μm. The composite material preferably further comprises at least one hydrophilicising and/or hygroscopic agent disposed at least in the region of the surface of the composite material.

Triclinic zinc molybdate can be produced by ultrasound-assisted reaction of one or more water-soluble molybdates with one or more water-soluble zinc (II) salts. For this purpose, aqueous solutions of molybdate and zinc salt are prepared separately from one another and brought into contact under the influence of ultrasound. The presence of ultrasound causes zinc molybdate to crystallise out in a triclinic crystal structure. The particle size of the zinc molybdate can be adjusted by the duration and intensity of the ultrasound. In a preferred embodiment of the invention, triclinic zinc molybdate is produced by bringing an aqueous solution of one or more alkali or alkaline earth molybdates into contact with an aqueous solution of one or more zinc (II) salts. Sodium molybdate dihydrate, for example, can be used as the water-soluble zinc molybdate. For example, a zinc halide such as zinc chloride can be used as the zinc (II) salt. The two salt solutions are preferably reacted at room temperature in the presence of ultrasound at a frequency of more than 15 kHz, in particular 20-30 kHz. For maximum efficacy, zinc molybdate must exist in a crystal lattice that is as free of defects as possible. Ultrasound treatment ensures this. Mixing the reactants as water-soluble molybdates with one or more water-soluble zinc salts without energy input does not lead to the formation of an optimal crystal structure, thereby resulting in a lack of or reduced efficacy compared to the optimal crystal structure according to the invention.

Producing triclinic ZnMn0₄ by means of ultrasound also allows, in particular, the defined provision of particles in the submicron range, that is to say, greater than 0.1 μm and less than 1 μm, in accordance with the invention.

Another aspect of use relates to the use of polyoxometalates to combat microorganisms and in particular coronaviruses. In this aspect, all polyoxometalates can be used as described above.

The polyoxometalate used preferably comprises vanadium (V), niobium (V), tantalum (V), molybdenum (VI) and/or tungsten (VI). Molybdenum (VI), tungsten (VI) and mixtures thereof are particularly preferred. In mixtures of molybdenum (VI) and tungsten (VI), atomic ratios of 3:1 to 1:3 and especially 1:1 or 2:1 are preferred.

These are particularly preferably used to combat microorganisms and in particular coronaviruses as described above. The polyoxometalate used is preferably [H₂Mo₆W₆O₄₂]¹⁰⁻.

Particularly preferably, polyoxometalates in the form Mo:W 1:1 [H₂Mo₆W₆O₄₂]¹⁰⁻ (paramolybdotungstate) or Mo:W 2:1 [H₂Mo₆W₆O₄₂]¹⁰⁻ are used.

Microorganisms are preferably influenza viruses and hepatitis B viruses, flavivirus, HIV, Epstein-Barr virus, norovirus, hepatitis C viruses, enveloped viruses such as herpes viruses and/or coronaviruses.

Coronaviruses may include orthocoronaviruses, in particular betacoronaviruses (Beta-CoV), such as SARS-CoV-2 (219-nCoV) and in particular mutants thereof such as the Alpha, Beta, Gamma or Lambda mutants, SARS-CoV or MERS-CoV.

The present invention will be further illustrated by the following examples.

### EXAMPLE

### A)

2% polyoxometalate Mo:W 2:1 in combination with 1% zinc molybdate was prepared to maintain the electrostatic charge of the surface.

2% polyoxometalate Mo:W 2:1 was used in combination with zinc to form various composite materials, such as polyimines.

Production of polyoxometalates Mo:W 2:1 and provision of zinc molybdate are carried out according to established approaches.

The coating material is silicon dioxide-water glass, which dries on a surface within 20 minutes and results in a transparent layer. However, coatings with liquid polyurethane, silicone and lacquers are also available.

Polyoxometalates are broadly effective against a range of viruses including hepatitis B, C, herpes, avian flu, swine flu, influenza, Covid-19, etc.

The surface, finished with submicron particles of polyoxometalate Mo:W 2:1, fulfils a number of essential requirements which are set out in the following table.
Broad antiviral activity against coronaviruses and other enveloped pathogenic viruses as well as multi-resistant bacterial microorganisms including fungi.
Rapid elimination of pathogenic viruses. Coronaviruses on a colonised surface, within 30 minutes.
No resistance induction.
Permanent effectiveness over a period of years. Documented over 10 years. No elution of polyoxometalates from the surface. Polyoxometalates are insoluble in water, alcohol and surfactants.
No loss of efficacy after 1000 cleanings with surfactants.
No toxicity.
Heat-stable up to 400° C.

Zinc molybdate shows inactivation compared to molybdenum trioxide for the studied influenza viruses. The virus titre of the influenza virus A/H1N1 was reduced by 1.33 LG.

### B)

Paramolybdotungstate Mo:W 1:1 [H₂Mo₆W₆O₄₂]¹⁰⁻ shows a 4 log reduction of coronaviruses in 2 hours in EN 14476 (Liquid Disinfectant Test). 88% more coronaviruses were killed on the treated surfaces than on a control surface, also in 2 hours.

### C)

A standard test method was used to measure viral activity on plastics and other non-porous surfaces of anti-virally treated products.

A test suspension of the virus is inoculated onto a test plastic surface and covered with a cover film. The surface is maintained at a specified temperature for a defined period. At the end of the contact time, media is added to the surface of the plastic and the surface is washed over to recover any remaining organisms. The number of surviving organisms which can be recovered from the surface is determined quantitatively taking in to account the test surface size.

| | |
|---|---|
| Test information | Deviation |

| | |
|---|---|
| Product name | Control - PE without test - |
| | polyethylene + polyoxometalate % |
| | Mo:W2:1 + glyceryl stearate |
| Storage conditions | Room temperature |
| Appearance of the | Control - white surface |
| product | Test - grey surface |
| Test concentrations | As supplied |
| Test temperature | 20° C. ± 1° C. |
| Incubation temperature | 37° C. ± 1° C. |
| Identification of | Feline coronavirus, Munich strain |
| viral strains: | |
| Contact times | 24 hours |
| Stability and | No change observed |
| appearance during test | |

### Result:

A 2.1111 log reduction (99.22%) against “feline coronavirus” is achieved under the conditions described above.

### Test Results

| | |
|---|---|
| Cytotoxicity (test) | Negative: |
| Cytotoxicity (control) | Negative: |

Inactivation control

| | Log recovered | Difference | Valid |
|---|---|---|---|
| Test | St | 0.00 | Y |
| Control (untreated) | Su | 0.08 | Y |
| Negative control | Sn | N/A | N/A |

Log recovery

| | | | | | Logs recovered | |
|---|---|---|---|---|---|---|
| | 1 | 2 | 3 | Average | per surface | |
| Test | 3.50 | 3.50 | 3.50 | 3.50 | At | 5.50 |
| Control (t) | 5.63 | 5.63 | 5.58 | 5.61 | Ut | 7.61 |
| Control (0) | 6.00 | 6.04 | 6.00 | 6.01 | Uo | 8.01 |

Antiviral activity per surface (R)

2.11
R = (Ut − Uo) − (At − Uo)

1. An in vitro mixture comprising polyoxometalates and zinc molybdate (ZnMoO₄), preferably in the form of particles having a triclinic crystal structure and an average particle size between 0.1 μm and 5.0 μm, wherein said polyoxometalates and zinc molybdate (ZnMoO₄) are in an amount sufficient for combating microorganisms.

2. The in vitro mixture according to claim 1, wherein the microorganisms are viruses, preferably influenza viruses, hepatitis B viruses, flavivirus, HIV, Epstein-Barr virus (EBV), norovirus, hepatitis C viruses, enveloped viruses such as herpes viruses and/or coronaviruses.

3. The in vitro mixture according to claim 1, wherein the coronaviruses are orthocoronaviruses, in particular betacoronaviruses (Beta-CoV), such as SARS-CoV-2 (2019-nCoV), SARS-CoV, and/or MERS-CoV, and in particular mutants thereof, such as the Alpha, Beta, Gamma, Kappa, Lambda and/or Delta variants thereof.

4. The in vitro mixture according to claim 1, wherein ZnMoO₄ is triclinic and/or the average grain size of ZnMoO₄ is in the range of 0.15 μm to less than 1.0 μm, preferably in the range of approx. 0.2 μm to approx. 0.8 μm.

5. The in vitro mixture according to claim 1, wherein combating microorganisms comprises virus inactivation.

6. The in vitro mixture according to claim 1, wherein the polyoxometalate comprises vanadium (V), niobium (V), tantalum (V), molybdenum (VI) and/or tungsten (VI).

7. The in vitro mixture according to claim 1, wherein polyoxometalate and zinc molybdate are used in a weight ratio of 10:1 to 1:10, more preferably 5:1 to 1:5 and even more preferably approx. 2:1.

8. The in vitro mixture according to claim 1, wherein the mixture comprising polyoxometalate and ZnMoO₄ is at least partially coated and/or agglomerated with a hydrophilicising and/or hygroscopic agent.

9. In vitro method for combating viruses, in particular coronaviruses, whereby polyoxometalate and zinc molybdate (ZnMoO₄), the latter preferably having a triclinic crystal structure and an average particle size between 0.1 μm and 5.0 μm, are brought into contact with a composition suspected of containing viruses, in particular coronaviruses.

10. Method according to claim 9, wherein the polyoxometalate comprises vanadium (V), niobium (V), tantalum (V), molybdenum (VI) and/or tungsten (VI).

11. Method according to claim 9 or 10, wherein the mixture comprising polyoxometalate and ZnMoO₄ is used in the form of a composite material having polyoxometalate and/or ZnMoO₄ at least on its surface.

12. Method according to claim 9, wherein the composite material further comprises at least one hydrophilicising and/or hygroscopic agent disposed at least in the region of the surface of the composite material.

13. Method according to claim 9, wherein the mass content of ZnMoO₄ relative to the total mass of the composite material or liquid composition is from 0.1% to 80%, in particular from 1.5% to 30%, and preferably from 1.8% to 5.0%.

14. Composition comprising a mixture of polyoxometalate and ZnMoO₄ as defined in claim 1.

15. Composite material comprising a mixture of polyoxometalate and ZnMoO₄ as defined in claim 1.

16. Face mask comprising a coating comprising a mixture of polyoxometalate and ZnMoO₄ as defined in claim 1.

17. A method for combating microorganisms comprising applying polyoxometalates in an amount sufficient to combat microorganisms, in particular coronaviruses.

18. The method according to claim 17, wherein the polyoxometalate is [H₂Mo₆W₆O₄₂]¹⁰⁻.

19. The method according to claim 17, wherein Mo:W 1:1 [H₂Mo₆W₆O₄₂]¹⁰⁻ (paramolybdotungstate) and/or or Mo:W 2:1 [H₂Mo₆W₆O₄₂]¹⁰⁻ is used.

20. The method according to claim 17, wherein the microorganisms are viruses, preferably influenza viruses, hepatitis B viruses, flavivirus, HIV, Epstein-Barr virus (EBV), norovirus, hepatitis C viruses, enveloped viruses such as herpes viruses and/or coronaviruses.

21. The method according to claim 17, wherein the coronaviruses comprise orthocoronaviruses, in particular betacoronaviruses (Beta-CoV), such as SARS-CoV-2 (2019-nCoV), SARS-CoV, and/or MERS-CoV, in particular the Alpha (B.1.1.7), Beta (B.1.351), Gamma (P.1), Lambda (C.37), B.1.525 or Delta (B1.617, B.1.617.1, B.1.617.2) mutants of SARS-CoV-2.
